(19) United States
(12) Patent Application Publication
(10) Pub. No.: US 2010/0204044 A1
(43) Pub. Date: Aug. 12, 2010

(54) Carrier and method of producing the same

(75) Inventors: Kazuo Asaki, Toyama (JP); Susumu Sunagoda, Toyama-shi (JP); Hisashi Takahashi, Yokohama-shi (JP)

Correspondence Address: MASUVALLEY & PARTNERS, 8765 AERO DRIVE, SUITE 312, SAN DIEGO, CA, 92123, US

(73) Assignees: Kohsei Co., Ltd., Tokyo (JP); Kureha Yushi Kogyo Co., Ltd., Toyama-shi (JP)

(21) Appl. No.: 12/658,185

(22) Filed: Feb. 3, 2010

(30) Foreign Application Priority Data
Feb. 7, 2009 (JP) 2009-026817

(51) Int. Cl. B01J 32/00

(52) U.S. Cl. 502/439

(57) ABSTRACT

The method of producing a carrier of the invention includes a step of kneading the starting carrier components, solid binding agent, liquid binding agent and diluted nitric acid water. The starting carrier components comprise aluminum hydroxide, pseudoboehmite, γ-alumina, powdery silica gel, powdery natural silica and zeolite. The solid binding agent comprises a powder of α-starch (rice), α-starch (potato), α-starch (tapioca), funori (glue plant), crystalline cellulose and powdery cellulose. The liquid binding agent comprises colloidal alumina, colloidal silica and polyvinyl alcohol. As a de-firing agent, further, there are used wood powder, charcoal powder, rice flour, wheat flour, barley flour, buck wheat flour and corn. The carrier has a pore volume in a range of 0.52 to 0.84 cc/g and a side crushing strength in a range of 2.2 to 11.0 kgf/particle.

This application claims priority from Japanese Patent Application No. 2009-026817 filed Feb. 7, 2009, which is incorporated by reference.

### BACKGROUND OF THE INVENTION

This invention relates to a novel carrier. The invention, further, relates to a novel method of producing the carrier.

A carrier of a catalyst used for a variety of chemical reactions desirably has a large pore volume for increasing the active site to promote the reaction. It is, further, desired that the starting material and the reaction product are easily diffused in the carrier to promote the reaction. Further, a catalyst of the egg-shell type utilizes only the surfaces of the carrier and, therefore, it is desired to increase the surface areas.

There have been reported an alumina carrier having a large pore volume and a large strength, a hydrogenated and demetallized catalyst using the alumina carrier, and a method of their production (see Japanese Patent Application Publication No. 2008-212798).

So far, further, though the strength of the molded body catalyst used to be improved relying upon the individual starting molded body components, there have now been reported a method of improving the strength of the molded body by drying without relying upon the starting molded body components and a method of producing an alumina-containing porous inorganic oxide carrier suited for the hydrogenated catalysts (see Japanese Patent Application Publication 2005-13930).

There has, further, been reported a catalyst carrier featuring excellent side crushing strength, the carrier components exhibiting very excellent activity per a unit weight of ruthenium, and featuring excellent heat resistance capable of maintaining high activity even under high temperature conditions of calcining and reaction (see Japanese Patent Application Publication No. H10-52639).

According to the above prior arts, however, if the pore volume increases, the mechanical strength of the carrier decreases, which invites a problem in that the carrier is crushed or is lost during the reaction. To maintain the mechanical strength of the carrier above a predetermined level, further, a mono-modal pore distribution can be formed, which, however, makes it difficult to produce a carrier having a bi-modal pore distribution or a tri-modal pore distribution for facilitating the diffusion of the starting material or the reaction product. Besides, there remains a problem in that it is difficult to increase the surface areas of the carrier.

It has, therefore, been desired to develop a novel carrier and its production method to solve the above problems.

The present invention was accomplished in view of the above problems, and has an object of providing a novel carrier.

The invention, further, has an object of providing a novel method of producing the carrier.

### SUMMARY OF THE INVENTION

In order to solve the above problems and to achieve the objects of the invention, a carrier of the invention has a pore volume lying in a range of 0.52 to 0.84 cc/g and a side crushing strength lying in a range of 2.2 to 11.0 kgf/particle.

Though not limited, it is desired that the material is any one of alumina, silica or zeolite, or any two or more of them used in combination. Though not limited, further, it is desired that the central particle size lies in a range of 2.5 to 15 mm.

The carrier of the invention has grooves formed in the surface thereof.

Though not limited, it is desired that the material is any one of alumina, silica or zeolite, or any two or more of them in combination. Though not limited, further, it is desired that the central particle size lies in a range of 2.5 to 15 mm. Further, though not limited, it is desired that the width of surfaces formed among the neighboring grooves is in a range of 0.20 to 0.30 mm, the depth of the grooves is in a range of 0.25 to 0.30 mm, and the pitch of the grooves is in a range of 0.25 to 0.35 mm.

The method of producing the carrier of the invention includes a step of kneading the starting carrier components, solid binding agent, liquid binding agent and diluted nitric acid water.

Though not limited, it is desired that the starting carrier components comprise any one of aluminum hydroxide, pseudoboehmite, γ-alumina, powdery silica gel, powdery natural silica or zeolite, or any two or more of them in combination. Further, though not limited, it is desired that the aluminum hydroxide is in a range of 1 to 30% by mass, the pseudoboehmite is in a range of 50 to 98% by mass, and the γ-alumina is in a range of 1 to 40% by mass. Though not limited, further, it is desired that the solid binding agent comprises any one of a powder of α-starch (rice), α-starch (potato), α-starch (tapioca), funori (glue plant), crystalline cellulose or powdery cellulose, or any two or more of them in combination. Further, though not limited, it is desired that the solid binding agent is blended in an amount in a range of 1 to 10% by mass relative to the starting carrier components. Though not limited, further, the liquid binding agent desirably comprises any one of colloidal alumina, colloidal silica or polyvinyl alcohol, or any two or more of them in combination. Further, though not limited, the liquid binding agent is blended desirably in an amount in a range of 1 to 10% by mass relative to the starting carrier components. Further, not limited, it is desired that the diluted nitric acid water has a nitric acid concentration in a range of 0.5 to 1.5% by mass and is blended in an amount in a range of 25 to 60% by mass in the starting materials that are fed. Further, though not limited, the diluted nitric acid water, desirably, has a chlorine concentration in a range of not larger than 100 ppm. Further, though not limited, it is often desired to use, as a de-firing agent, any one of wood powder, charcoal powder, rice flour, wheat flour, barley flour, buck wheat flour or corn, or any two or more of them in combination. Further, though not limited, the de-firing agent is blended in an amount, desirably, in a range of 3 to 15% by mass relative to the starting carrier components.

### BRIEF DESCRIPTION OF THE DRAWINGS

FIG. 1 is a diagram illustrating a method of producing a carrier and a plant for producing the carrier.

FIG. 2 includes a data sheet of pore distribution of the carrier and a diagram showing an integrated pore volume distribution and a Log differential pore volume distribution of the carrier.

FIG. 3 is an scanning electron microphotograph of the surface of the carrier.

FIG. 4 includes a data sheet of pore distribution of a carrier and a diagram showing an integrated pore volume distribution and a Log differential pore volume distribution of the carrier.

FIG. 5 includes a data sheet of pore distribution of a carrier and a diagram showing an integrated pore volume distribution and a Log differential pore volume distribution of the carrier.

FIG. 6 includes a data sheet of pore distribution of a carrier and a diagram showing an integrated pore volume distribution and a Log differential pore volume distribution of the carrier.

### DETAILED DESCRIPTION OF THE INVENTION

A mode for carrying out the invention will now be described.

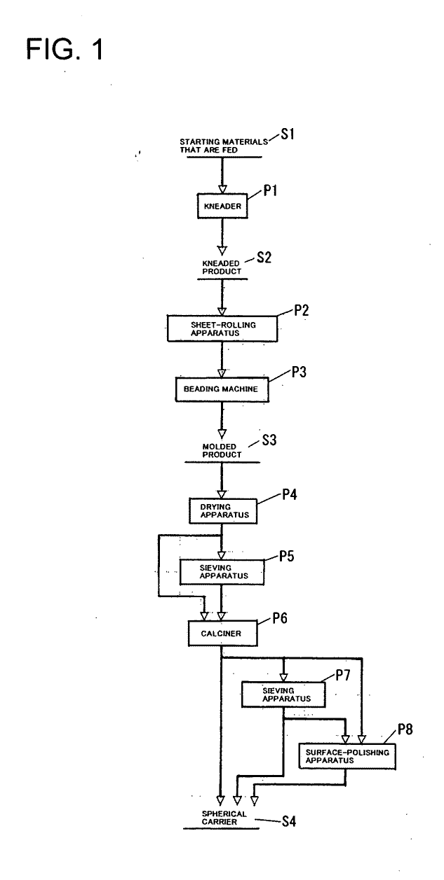

A method of producing a carrier and a plant for producing the carrier will be described with reference to FIG. 1. The method of producing the carrier includes a step of kneading the starting carrier components, solid binding agent, liquid binding agent and diluted nitric acid water. The plant for producing the carrier includes a kneader for kneading the starting carrier components, solid binding agent, liquid binding agent and diluted nitric acid water together, a beading machine for forming the kneaded product into a molded product thereof, and a calciner for calcining the molded product.

The kneading step will be described. In the kneading step, starting materials S1 that are fed are kneaded by a kneader P1

The starting materials include starting carrier components, solid binding agent, liquid binding agent, de-firing agent, diluted nitric acid water and the like. Here, the de-firing agent is arbitrarily blended.

As the starting carrier components, there can be used any one of alumina-type starting carrier component such as aluminum hydroxide (Al(OH)₃) pseudoboehmite (Al₂O₃) or γ-alumina (Al₂O₃), silica-type starting carrier component such as powdery silica gel (SiO₂) or powdery natural silica (SiO₂), or zeolite (Me₂/nO.Al₂O₃.xSiO₂.yH₂O), or any two or more of them in combination.

It is desired that the particle size of the alumina-type starting carrier components lies in a range of 10 to 60 μm. If the particle size is not smaller than 10 μm, an advantage is obtained in that the side crushing strength increases and the yield increases. If the particle size is not larger than 60 μm, an advantage is obtained in that the side crushing strength increases and the yield increases.

It is desired that the particle size of the silica-type starting carrier components lies in a range of 4 to 25 μm. If the particle size is not smaller than 4 μm, an advantage is obtained in that the side crushing strength increases and the yield increases. If the particle size is not larger than 25 μm, an advantage is obtained in that the side crushing strength increases and the yield increases.

It is desired that the particle size of zeolite lies in a range of 3 to 18 μm. If the particle size is not smaller than 3 μm, an advantage is obtained in that the side crushing strength increases and the yield increases. If the particle size is not larger than 18 μm, an advantage is obtained in that the side crushing strength increases and the yield increases.

When two or more kinds of starting carrier components are used, their blending ratio is arbitrary.

When two or more kinds of starting carrier components are used including aluminum hydroxide (Al(OH)₃), pseudoboehmite (Al₂O₃) and γ-alumina (Al₂O₃), it is desired that the aluminum hydroxide (Al(OH)₃) is in a range of 1 to 30% by mass, the pseudoboehmite (Al₂O₃) is in a range of 50 to 98% by mass and the γ-alumina (Al₂O₃) is in a range of 1 to 40% by mass. When the blending ratios of the aluminum hydroxide (Al(OH)₃), pseudoboehmite (Al₂O₃) and γ-alumina (Al₂O₃) are in the above ranges, an advantage is obtained in that the side crushing strength increases and the yield increases.

As the solid binding agent, there can be used any one of a powder of α-starch (rice), α-starch (potato), α-starch (tapioca), funori (glue plant), crystalline cellulose or powdery cellulose, or any two or more of them in combination.

It is desired that the particle diameter of the solid binding agent is in a range of 5 to 350 μm. If the particle size is not smaller than 5 μm, an advantage is obtained in that the side crushing strength increases, the yield increases and the pore distribution becomes bi-modal. If the particle size is not larger than 350 μm, an advantage is obtained in that the side crushing strength increases, the yield increases and the pore distribution becomes bi-modal.

It is desired that the amount of blending the solid binding agent is in a range of 1 to 10% by mass relative to the starting carrier components. If the blending amount is not smaller than 1% by mass, an advantage is obtained in that the side crushing strength increases, the yield increases and the pore distribution becomes bi-modal. If the blending amount is not larger than 10% by mass, an advantage is obtained in that the side crushing strength increases, the yield increases and the pore distribution becomes bi-modal.

As the liquid binding agent, there can be used any one of colloidal alumina, colloidal silica or polyvinyl alcohol, or any two or more of them in combination.

It is desired that the amount of blending the liquid binding agent is in a range of 1 to 10% by mass relative to the starting carrier components. If the blending amount is not smaller than 1% by mass, an advantage is obtained in that the yield increases. If the blending amount is not larger than 10% by mass, an advantage is obtained in that the yield increases.

As the de-firing agent, there can be used any one of wood powder, charcoal powder, cereal flour (rice flour, wheat flour, barley flour, buck wheat flour, corn flour or the like flour), or any two or more of them in combination.

The particle size of the de-firing agent is, desirably, in a range of 1 to 300 μm. If the particle size is not smaller than 1 μm, an advantage is obtained in that the pore distribution becomes tri-modal without lowering the yield. If the particle size is not larger than 300 μm, an advantage is obtained in that the pore distribution becomes tri-modal without lowering the yield.

It is desired that the amount of blending the de-firing agent is in a range of 3 to 15% by mass relative to the starting carrier components. If the blending amount is not smaller than 3% by mass, an advantage is obtained in that the pore distribution becomes tri-modal without lowering the yield. If the blending amount is not larger than 15% by mass, an advantage is obtained in that the pore distribution becomes tri-modal without lowering the yield.

As the diluted nitric acid water, there can be used the one having a nitric acid (HNO₃) concentration of 0.5 to 1.5% by mass.

The amount of blending the diluted nitric acid water is desirably in a range of 25 to 60% by mass in the starting materials that are fed. If the blending amount is not smaller than 25% by mass, an advantage is obtained in that the yield increases. If the blending amount is not larger than 60% by mass, an advantage is obtained in that the yield increases.

It is desired that the chlorine concentration in the diluted nitric acid water is in a range of not larger than 100 ppm. If the chlorine concentration is not larger than 100 ppm, ad advantage is obtained that the yield increases and no damage is, caused to the calcining facility.

As the kneader, a twin-armed kneader can be used.

The kneading temperature is desirably in a range of 5 to 50° C. If the kneading temperature is not lower than 5° C., an advantage is obtained in that the yield increases. If the kneading temperature is not higher than 50° C., an advantage is obtained in that the yield increases.

The kneading time is desirably in a range of 10 to 25 minutes. If the kneading time is not shorter than 10 minutes, an advantage is obtained in that the yield increases. If the kneading time is not longer than 25 minutes, an advantage is obtained in that the yield increases.

A step of rolling a sheet will be described. In the step of rolling the sheet, a kneaded product S2 is rolled into a sheet through a sheet-rolling apparatus P2 so as to be easily fed to a beading machine P3.

The sheet has a thickness, desirably, in a range of 10 to 30 mm. If the thickness of the sheet is not smaller than 10 mm, an advantage is obtained in that the yield increases. If the thickness of the sheet is not larger than 30 mm, an advantage is obtained in that the yield increases.

A beading step will be described. In the beading step, a molded product S3 having a mesh pattern is molded from the sheet-like kneaded product by using the beading machine P3.

In the beading machine P3, the sheet-like kneaded product is crammed into grooves of a grooved roll, and is scratched off by a scratching blade. The kneaded product that is scratched off falls on a molding roll, and is crumpled into a round shape by a crumpling board. The scratched amount of the kneaded product is so determined that a predetermined particle size is attained after calcining.

As the surface material of the molding roll, hard chromium can be plated.

The diameter of the molding roll lies, desirably, in a range of 350 to 400 mm. It is, further, desired that the revolving speed of the molding roll lies in a range of 18 to 24 rpm. If the diameter and the revolving speed of the molding roll lie in the above ranges, an advantage is obtained in that the yield increases.

The molding roll has grooves formed in the surface thereof in the vertical direction of the rotary shaft. The molding roll does not have to be provided with grooves in the surface thereof.

The width of surfaces formed among the neighboring grooves is, desirably, in a range of 0.04 to 0.06 mm. It is, further, desired that the grooves have a depth in a range of 0.25 to 0.30 mm. Further, the grooves have a pitch, desirably, in a range of 0.25 to 0.35 mm. If the width of surfaces among the grooves, depth of grooves and pitch of grooves lie in the above ranges, an advantage is obtained in that the yield increases and a mesh pattern of a rhombic shape can be formed on the surfaces of the spherical carriers.

A serge or the like cloth can be used as the surface material of the crumpling board.

The number of vibration of the crumpling board is, desirably, in a range of 600 to 700 times/min. It is, further, desired the amplitude of the crumpling board is in a range of 1.3 to 1.8 times as large as the size of the particles after molded. If the number of vibration of the crumpling board and the amplitude of the crumpling board lie in the above ranges, an advantage is obtained in that the yield increases and a mesh pattern of a rhombic shape can be formed on the surfaces of the spherical carriers.

A drying step will be described below. In the drying step, the molded product S3 is dried by natural drying and by using a drying apparatus P4. Here, the natural drying may be omitted.

The temperature in the natural drying is, desirably, in a range of 5 to 35° C. It is, further, desired that the time for the natural drying is in a range of 5 to 24 hours so that the surfaces are dried to become white. If the temperature of the natural drying and the time for the natural drying lie in the above ranges, an advantage is obtained in that the yield increases.

As the drying apparatus, there can be employed a batch-type drying machine (incubator, etc.) or a continuous-type drying machine (belt dryer, etc.).

The drying temperature in the drying apparatus is, desirably, in a range of 60 to 90° C. It is, further, desired that the drying time by the drying apparatus lies in a range of 0.5 to 10 hours. If the drying temperature and the drying time of the drying apparatus lie in the above ranges, an advantage is obtained in that the yield increases.

A sieving step will now be described. In the sieving step, products of poor shapes after the molding are sorted out by using a sieving apparatus P5. Here, the sieving step may be omitted.

As the sieving apparatus, there can be employed a vibrating sieve or a trommel.

The perforation size of the sieve is so selected that a target particle size ±5% is attained.

A calcining step will be described. In the calcining step, the dried molded product is calcined by using a calciner P6.

As the calciner, there can be employed a batch-type calcining furnace (muffle furnace, etc.), a continuous-type calcining furnace (kiln, etc.) or a tunnel furnace.

The calcining temperature in the calciner is, desirably, in a range of 650 to 1100° C. It is, further, desired that the calcining time by using the calciner is in a range of 5 to 20 hours. If the calcining temperature in the calciner and the calcining time by the calciner lie in the above ranges, an advantage is obtained in that the side crushing strength increases and the yield increases.

A sieving step will be described. In the sieving step, products of poor shapes after the calcining are sorted by using a sieving apparatus P7. Here, the sieving step may be omitted.

As the sieving apparatus, there can be employed a vibrating sieve or a trommel.

The perforation size of the sieve is so selected that a target particle size ±5% is attained.

A surface-polishing step will be described. In the surface-polishing step, the surfaces of the calcined products are polished by using a surface-polishing apparatus P8 to reduce the depth of grooves of mesh on the surfaces of spherical carriers. The surface-polishing step may be omitted.

As the surface-polishing apparatus, there can be employed a panpelletizer or a concrete mixer.

Described below is the carrier produced by the above production method and the production plant.

The carrier has a pore volume in a range of 0.52 to 0.84 cc/g. If the pore volume of the carrier lies in this range, an advantage is obtained in that the volume density decreases and the specific surface area increases.

The carrier has micropores (6 to 100 nm) in a range of 0.32 to 0.62 cc/g. If the micropores of the carrier lies in the above range, an advantage is obtained in that the specific surface area increases thereby increasing the active site as a catalyst.

The carrier has macropores (200 to 3000 nm) in a range of 0.11 to 0.18 cc/g. If the macropores of the carrier lies in the above range, an advantage is obtained in that diffusion into the interior of the spherical carriers and diffusion from interior of the spherical carriers are enhanced.

The carrier has ultramacropores (6000 to 30000 nm) in a range of 0.01 to 0.07 cc/g. If the ultramacropores of the carrier lies in the above range, an advantage is obtained in that diffusion into the interior of the spherical carriers and diffusion from interior of the spherical carriers are enhanced.

The carrier has a specific surface area in a range of 75 to 260 m²/g. If the specific surface area of the carrier lies in the above range, an advantage is obtained in that the active site increases as a catalyst.

The carrier has a side crushing strength in a range of 2.2 to 11.0 kgf/particle. If the side crushing strength of the carrier lies in the above range, an advantage is obtained in that the yield increases at the time of machining the catalyst and the catalyst is prevented from becoming powdery when being charged into the reactor and when being used.

The carrier has a central particle size in a range of 2.5 to 15 mm. If the central particle size of the carrier lies in the above range, an advantage is obtained in that the carrier can be used for a variety of applications.

As the carrier material, there can be used any one of alumina, silica or zeolite, or any two or more of them in combination.

The carrier has grooves of a continuing rhombic pattern formed in the surface thereof. The grooves of the rhombic pattern do not have to be formed.

A side of the rhombic shape has a length in a range of 150 to 350 μm. If the length of the side of the rhombic shape lies in the above range, an advantage is obtained in that the surface area of the spherical carrier increases.

The width of surfaces formed among the neighboring grooves lies in a range of 0.20 to 0.30 mm. The depth of grooves is in a range of 0.25 to 0.30 mm. Further, the pitch of grooves is in a range of 0.25 to 0.35 mm. If the width of surfaces among the grooves, depth of grooves and pitch of grooves lie in the above ranges, an advantage is obtained in that the surface area of the spherical carrier increases.

The carrier forming grooves has a surface area in a range of 125 to 140% relative to the surface area of the smooth spherical carrier. If the surface area of the carrier forming grooves lies in the above range, an advantage is obtained in that the surface area increases and the pressure loss decreases.

The yield of the carrier is in a range of 85 to 98%. If the yield of the carrier lies in the above range, an advantage is obtained in that the productivity can be increased while decreasing the cost of production.

The shape of the carrier is not limited to the spherical shape only. The carrier may, further, assume the shape of an extrusion-molded product.

The carrier can be used as catalyst carrier, gas-absorbing agent, wastewater treating/adsorbing agent, gas separator, ion-isolation resin carrier, and the like

It should be noted that the present invention can be put into practice not being limited to the above-mentioned embodiment only but also in the form of various other constitutions without departing from the scope of the invention, as a matter of course.

### EXAMPLES

Next, the invention will be concretely described by way of Examples to which only, however, the invention is not limited, as a matter of course.

Methods of evaluating the carrier will be described.

### Central Particle Size

Twenty carrier particles were picked up, and their diameters were measured by using a calipers to find a central value.

### Pore Volume

Measured based on the mercury intrusion porosity method by using a measuring apparatus (Pore-Sizer 9320 manufactured by Micromelliticsu Co.).

### Pore Distribution

Measured based on the mercury intrusion porosity method by using a measuring apparatus (Pore-Sizer 9320 manufactured by Micromellitics Co.).

### Specific Surface Area

The specific surface area was measured by using a specific surface area-measuring apparatus (FlowSorb III 2310 manufactured by Shimazu Seisakusho Co.).

### Side Erushing Strength

Twenty carrier particles were picked up, and were measured for their side crushing strengths to find an average value thereof. The measuring apparatus was a tablet side crushing strength-measuring apparatus (TH-203CP manufactured by Toyama Sangyo Co.).

### Observation of Surface Pattern

The surface of the carrier particle was observed by using an scanning electron microscope (VE-8800 manufactured by Keyense Co.).

### Surface Area

A mesh pattern of a rhombic shape was specified based on an scanning electron microphotograph, and a rugged area on the surface of the carrier particle was calculated.

### Yield

A ratio of the weight of the starting carrier components (excluding adhered water and water of crystallization) and the weight of the obtained carrier particles was found.

Preparation of the Carriers and the Evaluated Results of the carriers will be described below.

### Alumine Carrier

### Example 1

The starting materials that were fed were starting carrier components, solid binding agent, liquid binding agent and diluted nitric acid water. The starting carrier components contained 10% by mass of aluminum hydroxide (Al(OH)₃, particle size: 10 μm), 60% by mass of pseudobeohmite (Al₂O₃, particle size: 20 μm) and 30% by mass of γ-alumina (Al₂O₃, particle size: 40 μm). Here, “% by mass” of the starting carrier components represents a value relative to the total mass of the whole components. As the solid binding agent, there were used 2% by mass of powder of α-starch (rice) (particle size: 150 μm) and 5% by mass of powdery cellulose (particle size: 150 μm). As the liquid binding agent, there was used 5% by mass of colloidal alumina (of the type of acetic acid stabilizer). Here, “% by mass” of the solid binding agent and liquid binding agent represent values relative to the mass of the starting carrier components. There was, further, used 35% by mass of diluted nitric acid water (nitric acid (NHO₃) concentration: 1% by mass, chlorine concentration: 1 ppm). Here, “% by mass” of the diluted nitric acid water represents a value relative to the mass of the starting materials that were fed.

The starting materials that were fed were kneaded by using a twin-armed kneader at room temperature for 15 minutes. The kneaded product was rolled by using a sheet-rolling apparatus into a sheet of a thickness of 10 mm. In a beading machine, the sheet-like kneaded product was crammed into grooves of the grooved roll and was scratched off. The scratched kneaded product was allowed to fall on a molding roll (surface material: hard chromium plating, diameter: 375 mm, revolving speed: 21 rpm) and was crumpled by a crumpling board (surface material: serge, number of vibration: 600 to 700 times/min, amplitude: 1.3 to 1.8 times as great as the particle size after molded) into a round shape. The amount of the scratched kneaded product was so determined that a predetermined particle size was attained after calcining. Grooves were formed in the surface of the molding roll in the vertical direction of the rotary shaft. The width of the surfaces formed among the neighboring grooves was 0.05 mm, the depth of the grooves was 0.26 mm and the pitch of the grooves was 0.30 mm.

The molded product was naturally dried at room temperature for 5 to 24 hours until the surface thereof became white and was, thereafter, dried by using an incubator at 60° C. for 4 hours. After drying, the products having poor shapes were sorted out by using the sieving apparatus. The perforation size of the sieve was so selected as to attain a target particle size ±5%. After selecting, the products were calcined at 730° C. for 10 hours by using a muffle furnace. After calcining, the products having poor shapes were sorted out by using the sieving apparatus. The perforation size of the sieve was so selected as to attain a target particle size ±5%. As a result, a carrier was obtained in a spherical shape.

Table 1 shows the evaluated results of the carrier. The central particle size was 2.5 mm. The pore volume was large, and a bi-modal pore distribution containing micropores and macropores was confirmed. The specific surface area was large, too. The side crushing strength was large, too. A rhombic mesh pattern was observed on the surface of the carrier. The yield was large, too.

TABLE 1
Table 1 Starting materials fed for preparing carriers and evaluated results of the carriers

| | | | Example 1 | Example 2 | Example 3 |
|---|---|---|---|---|---|
| Starting | Al hydroxide | mass % | 10 | 10 | 10 |
| materials | pseuodoboehmite | mass % | 60 | 60 | 60 |
| | γ-alumina | mass % | 30 | 30 | 30 |
| | α-starch (rice) | mass % | 2 | 2 | 2 |
| | powdery cellulose | mass % | 5 | 5 | 5 |
| | colloidal alumina | mass % | 5 | 5 | 5 |
| | diluted nitric acid water | mass % | 35 | 35 | 35 |
| Carrier | central particle size | mm φ | 2.5 | 5 | 15 |
| | pore volume | cc/g | 0.69~0.73 | 0.66~0.70 | 0.66~0.70 |
| | micropores | nm, cc/g | 7~30, 0.42~0.46 | 7~30, 0.42~0.46 | 7~30, 0.42~0.46 |
| | macropores | nm, cc/g | 300~900, 0.11~0.13 | 300~900, 0.13~0.15 | 300~900, 0.13~0.15 |
| | ultramacropores | nm, cc/g | — | — | — |
| | specific surface area | m²/g | 160~170 | 160~170 | 160~170 |
| | side crushing strength | kgf/particle | 2.8~3.4 | 5.8~6.5 | 10.0~11.0 |
| | surface | | rhombic mesh pattern | rhombic mesh pattern | rhombic mesh pattern |
| | yield | % | ≧90 | ≧90 | ≧90 |

### Example 2

A carrier was prepared by the same method as in Example 1 but so changing the amount of the kneaded product scratched by the scratching blade as to attain a central particle size of 5.0 mm after calcining, and changing the amplitude of the crumpling board and the perforation size of the sieve depending on the particle size.

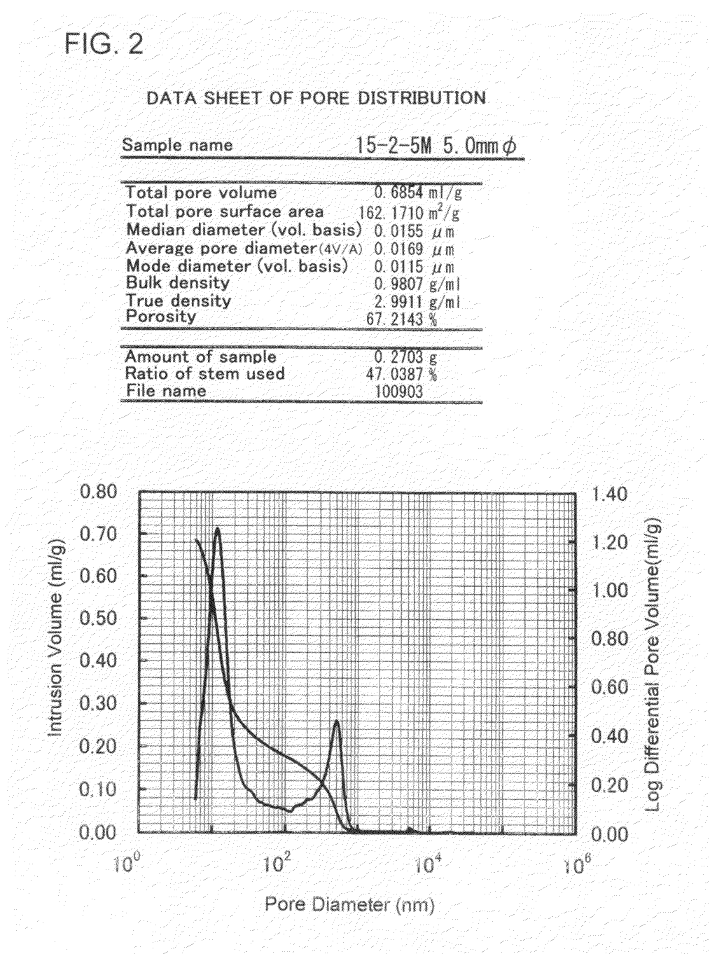

Table 1 shows the evaluated results of the carriers. FIG. 2 includes a data sheet of pore distributions of the carriers and a diagram showing integrated pore volume distributions and Log differential pore volume distribution of the carriers. The central particle size was 5.0 mm. The pore volume was large, and a bi-modal pore distribution containing micropores and macropores was confirmed. The specific surface area was large, too. The side crushing strength was large, too. A rhombic mesh pattern was observed on the surface of the carrier. The yield is large, too.

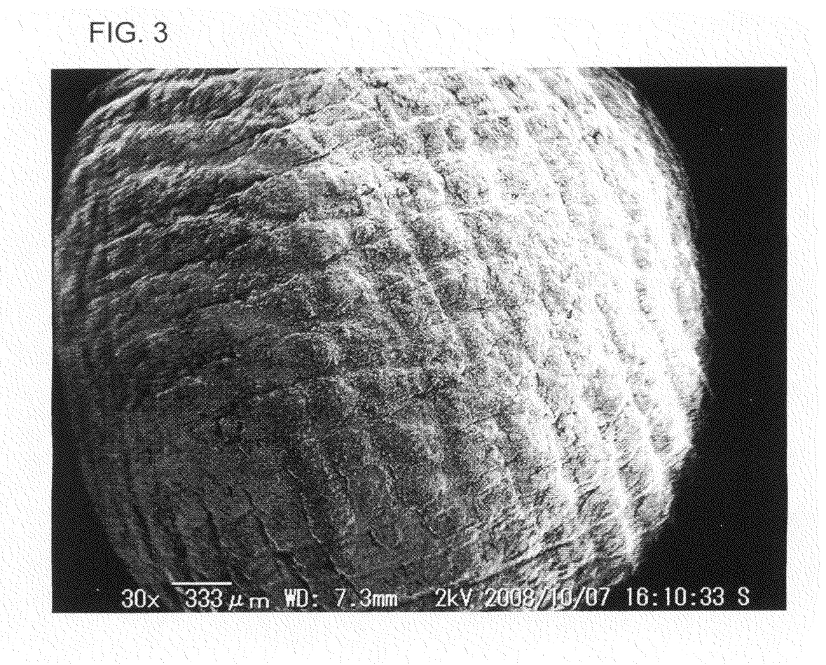

FIG. 3 is a scanning electron microphotograph of the surface of the carrier. Concerning the surface area of the carrier, grooved portions in the rhombic mesh pattern help increase the surface area as compared to the surface area of the spherical carrier having a smooth surface. A calculation of the surface area while observing the surface of the carrier by using an scanning electron microscope indicates that the surface areas of tilted surface portions of the grooves correspond to 35% of the surface area of a smooth spherical carrier. Therefore, grooves of the rhombic mesh pattern formed in the surface of the carrier increase the surface area by 35%.

### Comparative Example 1

The carrier was prepared in the same manner as in Example 2 but using, as the starting carrier components, 66.7% by mass of pseudoboehmite (Al₂O₃, particle size: 20 μm) and 33.3% by mass of γ-alumina (Al₂O₃, particle size: 40 μm).

As a result, the side crushing strength was 5.0 to 5.6 kgf/particle and the yield was 80 to 85%. Since no aluminum hydroxide was used as the starting carrier component, the side crushing strength and the yield were adversely affected to some extent.

### Comparative Example 2

The carrier was prepared in the same manner as in Example 2 but using, as the starting carrier components, 25% by mass of aluminum hydroxide(Al(OH)₃, particle size: 10 μm) and 75% by mass of γ-alumina (Al₂O₃, particle size: 40 μm).

As a result, the side crushing strength was 0.8 to 0.9 kgf/particle and the yield was not less than 90%. Since no pseudoboehmite was used as the starting carrier component, it was confirmed that the side crushing strength has greatly decreased

### Comparative Example 3

The carrier was prepared in the same manner as in Example 2 but using, as the starting carrier components, 14.3% by mass of aluminum hydroxide (Al (OH)₃, particle size: 10 μm) and 85.7% by mass of pseudoboehmite (Al₂O₃, particle size: 20 μm).

As a result, the side crushing strength was 2.4 to 2.8 kgf/particle and the yield was not less than 90%. Since no γ-alumina was used as the starting carrier component, it was confirmed that the side crushing strength has greatly decreased

### Comparative Example 4

The carrier was prepared in the same manner as in Example 2 but using no solid binding agent and using, as the liquid binding agent, 12% by mass of colloidal alumina.

As a result, the mono-modal pore distribution was recognized, the side crushing strength was 0.9 to 1.2 kgf/particle and the yield was 50 to 60%. Since no solid binding agent was used, the bi-modal pore distribution has disappeared, and it was confirmed that the side crushing strength and the yield have greatly decreased

### Comparative Example 5

The carrier was prepared in the same manner as in Example 2 but using no liquid binding agent and using, as the solid binding agent, 2% by mass of powder of α-starch (rice) (particle size: 150 g) and 5% by mass of powdery cellulose (particle size: 150 μm).

As a result, the side crushing strength was 5.8 to 6.5 kgf/particle and the yield was 53 to 62%. Since no liquid binding agent was used, it was confirmed that the yield has greatly decreased.

### Comparative Example 6

A carrier was prepared in the same manner as in Example 2 but using no diluted nitric acid water and using 35% by mass of natural water (chlorine content: 1 ppm).

As a result, the side crushing strength was 5.8 to 6.5 kgf/particle and the yield was 10 to 20%. Since no diluted nitric acid water was used, it was confirmed that the yield has greatly decreased

### Comparative Example 7

The carrier was prepared in the same manner as in Example 2 but setting the chlorine concentration in the diluted nitric acid water to be 350 ppm.

As a result, the side crushing strength was 5.8 to 6.5 kgf/particle and the yield was 48 to 57%. In the calcining step, damage to the calciner was recognized due to the generation of an HCl gas. Since the chlorine concentration has increased, it was confirmed that the yield has greatly decreased and the calciner was adversely affected.

### Example 3

The carrier was prepared in the same manner as in Example 1 but so setting the amount of the kneaded product scratched by the scratching blade that the central particle size was 15.0 mm after calcining, and varying the amplitude of the crumpling board and the perforation size of the sieve depending on the particle size.

Table 1 shows the evaluated results of the carrier. The central particle size was 15.0 mm. The pore volume was large, and a bi-modal pore distribution containing micropores and macropores was confirmed. The specific surface area was large, too. The side crushing strength was large. A rhombic mesh pattern was observed on the surface of the carrier. The yield was large, too.

### Examples 4, 5 and 6

The carriers in Examples 4, 5 and 6 were prepared in the same manner as in Examples 1, 2 and 3, respectively, but conducting the calcining at 970° C. for 15 hours.

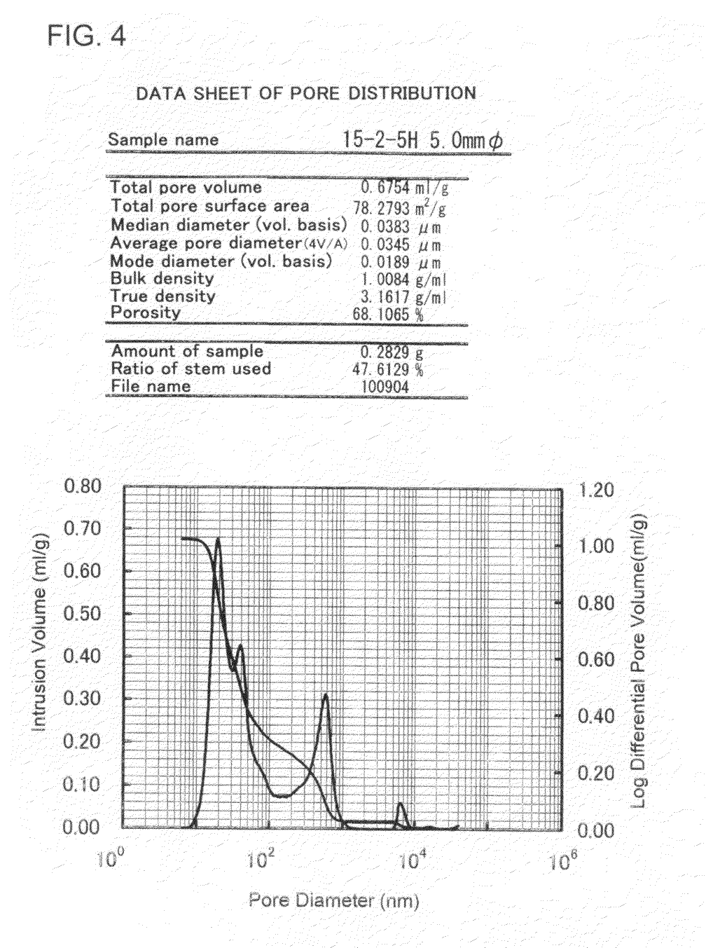

Table 2 shows the evaluated results of the carriers. FIG. 4 includes a data sheet of pore distributions of the carriers and a diagram showing integrated pore volume distributions and Log differential pore volume distributions of the carriers. The central particle sizes in Examples 4, 5 and 6 were 2.5 mm, 5.0 mm and 15.0 mm, respectively. It was confirmed that the pore volumes were large. In Example 4, a bi-modal pore distribution containing micropores and macropores was confirmed. In Examples 5 and 6, tri-modal pore distributions containing micropores, macropores and ultramicropores were confirmed. In Examples 4, 5 and 6, the specific surface areas were large, too. The side crushing strengths were large, too. A rhombic mesh pattern was observed on the surfaces of the carriers. The yields were large, too.

TABLE 2
Table 2 Starting materials fed for preparing carriers and evaluated results of the carriers

| | | | Example 4 | Example 5 | Example 6 |
|---|---|---|---|---|---|
| Starting | Al hydroxide | mass % | 10 | 10 | 10 |
| materials | pseuodoboehmite | mass % | 60 | 60 | 60 |
| | γ-alumina | mass % | 30 | 30 | 30 |
| | α-starch (rice) | mass % | 2 | 2 | 2 |
| | powdery cellulose | mass % | 5 | 5 | 5 |
| | colloidal alumina | mass % | 5 | 5 | 5 |
| | diluted nitric acid water | mass % | 35 | 35 | 35 |
| Carrier | central particle size | mm φ | 2.5 | 5 | 15 |
| | pore volume | cc/g | 0.68~0.72 | 0.66~0.70 | 0.66~0.70 |
| | micropores | nm, cc/g | 10~100, 0.46~0.50 | 10~100, 0.46~0.50 | 10~100, 0.46~0.50 |
| | macropores | nm, cc/g | 300~900, 0.12~0.14 | 300~900, 0.12~0.14 | 300~900, 0.12~0.14 |
| | ultramacropores | nm, cc/g | — | 6000~9000, 0.01 | 6000~9000, 0.01 |
| | specific surface area | m²/g | 80~95 | 75~90 | 75~90 |
| | side crushing strength | kgf/particle | 2.2~2.6 | 4.5~6.5 | 8.0~9.0 |
| | surface | | rhombic mesh pattern | rhombic mesh pattern | rhombic mesh pattern |
| | yield | % | ≧90 | ≧90 | ≧90 |

### Examples 7, 8 and 9

The carriers in Examples 7 and 9 were prepared in the same manner as in Examples 1 and 3 but blending 8% by mass of wood powder (particle size: 5 μm) as the de-firing agent. The carrier in Example 8 was prepared in the same manner as in Example 2 but blending 8% by mass of wood powder (particle size: 5 μm) as the de-firing agent, so setting the amount of the kneaded product scratched by the scratching blade that the central particle size was 4.0 mm after calcining, and varying the amplitude of the crumpling board and the perforation size of the sieve depending on the particle size. Here, “% by mass” of the de-firing agent represents a value relative to the mass of the starting carrier components.

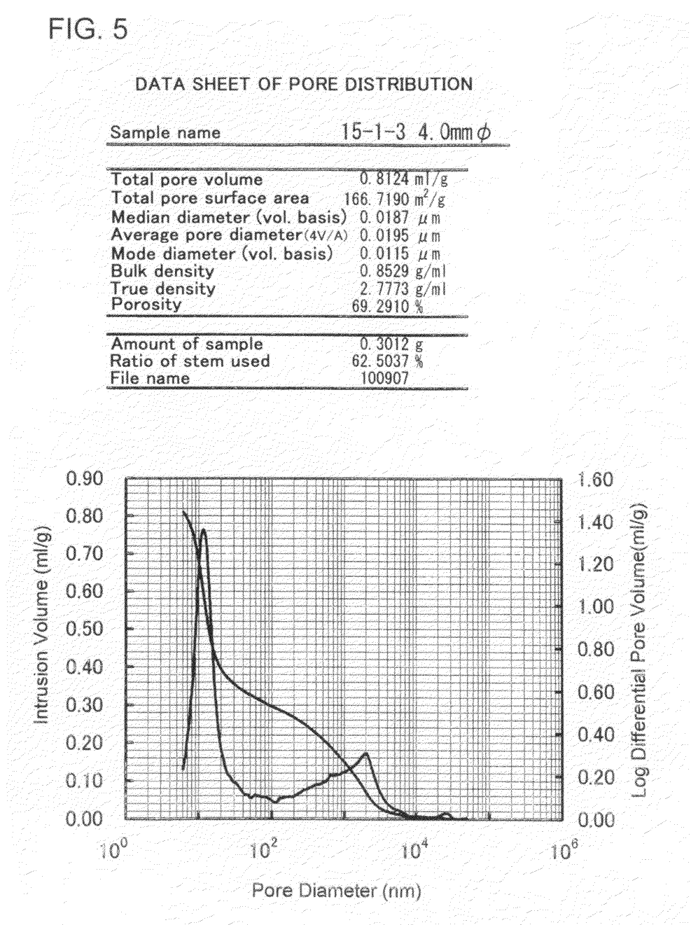

Table 3 shows the evaluated results of the carriers. FIG. 5 includes a data sheet of pore distributions of the carriers and a diagram showing integrated pore volume distributions and Log differential pore volume distributions of the carriers. The central particle sizes in Examples 7, 8 and 9 were 2.5 mm, 4.0 mm and 15.0 mm, respectively. It was confirmed that the pore volumes were large. A tri-modal pore distribution containing micropores, macropores and ultramacropores was confirmed. The specific surface areas were large, and the side crushing strengths were large, too. A rhombic mesh pattern was observed on the surfaces of the carriers. The yields were large, too.

TABLE 3
Table 3 Starting materials fed for preparing carriers and evaluated results of the carriers

| | | | Example 7 | Example 8 | Example 9 |
|---|---|---|---|---|---|
| Starting | Al hydroxide | mass % | 10 | 10 | 10 |
| materials | pseuodoboehmite | mass % | 60 | 60 | 60 |
| | γ-alumina | mass % | 30 | 30 | 30 |
| | α-starch (rice) | mass % | 2 | 2 | 2 |
| | powdery cellulose | mass % | 5 | 5 | 5 |
| | colloidal alumina | mass % | 5 | 5 | 5 |
| | diluted nitric acid water | mass % | 35 | 35 | 35 |
| | wood powder | mass % | 8 | 8 | 8 |
| Carrier | central particle size | mm φ | 2.5 | 4 | 15 |
| | pore volume | cc/g | 0.79~0.83 | 0.79~0.83 | 0.79~0.83 |
| | micropores | nm, cc/g | 7~30, 0.43~0.47 | 7~30, 0.43~0.47 | 7~30, 0.43~0.47 |
| | macropores | nm, cc/g | 600~3000, 0.16~0.18 | 600~3000, 0.16~0.18 | 600~3000, 0.16~0.18 |
| | ultramacropores | nm, cc/g | ≈25000, 0.01~0.05 | ≈25000, 0.01~0.05 | ≈25000, 0.01~0.05 |
| | specific surface area | m²/g | 160~175 | 160~175 | 160~175 |
| | side crushing strength | kgf/particle | 2.2~2.6 | 3.0~3.8 | 8.0~9.0 |
| | surface | | rhombic mesh pattern | rhombic mesh pattern | rhombic mesh pattern |
| | yield | % | ≧90 | ≧90 | ≧90 |

### Alumina-Silica Carrier

### Examples 10, 11 and 12

The carrier in Example 10 was prepared in the same manner as in Example 1 but using, as the starting carrier components, 10% by mass of aluminum hydroxide (Al(OH)₃, particle size: 50 μm), 50% by mass of pseudobeohmite (Al₂O₃, particle size: 30 μm), 25% by mass of γ-alumina (Al₂O₃, particle size: 50 μm), 15% by mass of powdery silica gel (SiO₂, particle size: 20 μm) and, as the solid binding agent, 5% by mass of powder of α-starch (rice) (particle size: 130 μm) and 2% by mass of powdery cellulose (particle size: 100 μm), as the liquid binding agent, 5% by mass of colloidal alumina and 2% by mass of colloidal silica (pH 9.5, ammonia stabilizer type), and 35% by mass of diluted nitric acid water (nitric acid (HNO₃) concentration: 0.8% by mass, chlorine concentration: 1 ppm).

The carriers in Example 11 and 12 were prepared in the same manner as in Examples 2 and 3 but using, as the starting carrier components, 10% by mass of aluminum hydroxide (Al(OH)₃, particle size: 50 μm), 60% by mass of pseudobeohmite (Al₂O₃, particle size: 30 μm), 30% by mass of γ-alumina (Al₂O₃, particle size: 50 μm), 15% by mass of powdery silica gel (SiO₂, particle size: 20 μm) and, as the solid binding agent, 5% by mass of powder of α-starch (rice) (particle size: 130 μm) and 2% by mass of powdery cellulose (particle size: 100 μm), as the liquid binding agent, 5% by mass of colloidal alumina and 2% by mass of colloidal silica (pH 9.5), and 35% by mass of diluted nitric acid water (nitric acid (HNO₃) concentration: 0.8% by mass, chlorine concentration: 1 ppm).

Table 4 shows the evaluated results of the carriers. The central particle sizes in Examples 10, 11 and 12 were 2.5 mm, 5.0 mm and 15.0 mm, respectively. It was confirmed that the pore volumes were large. A bi-modal pore distribution containing micropores and macropores was confirmed. The specific surface areas were large, and the side crushing strengths were large, too. A rhombic mesh pattern was observed on the surfaces of the carriers. The yields were large, too.

TABLE 4
Table 4 Starting materials fed for preparing carriers and evaluated results of the carriers

| | | | Example 10 | Example 11 | Example 12 |
|---|---|---|---|---|---|
| Starting | Al hydroxide | mass % | 10 | 10 | 10 |
| materials | pseuodoboehmite | mass % | 50 | 60 | 60 |
| | γ-alumina | mass % | 25 | 30 | 30 |
| | Powdery silica gel | mass % | 15 | 15 | 15 |
| | α-starch (rice) | mass % | 5 | 5 | 5 |
| | powdery cellulose | mass % | 2 | 2 | 2 |
| | colloidal alumina | mass % | 5 | 5 | 5 |
| | colloidal silica | mass % | 2 | 2 | 2 |
| | diluted nitric acid water | mass % | 35 | 35 | 35 |
| Carrier | central particle size | mm φ | 2.5 | 5 | 15 |
| | pore volume | cc/g | 0.67~0.71 | 0.65~0.69 | 0.65~0.69 |
| | micropores | nm, cc/g | 7~20, 0.40~0.44 | 7~20, 0.40~0.44 | 7~20, 0.40~0.44 |
| | macropores | nm, cc/g | 200~700, 0.11~0.13 | 200~700, 0.12~0.14 | 200~700, 0.12~0.14 |
| | ultramacropores | nm, cc/g | — | — | — |
| | specific surface area | m²/g | 170~180 | 170~180 | 170~180 |
| | side crushing strength | kgf/particle | 3.2~3.8 | 6.2~6.8 | 10.0~11.0 |
| | surface | | rhombic mesh pattern | rhombic mesh pattern | rhombic mesh pattern |
| | yield | % | ≧90 | ≧90 | ≧90 |

### Silica Carrier

### Examples 13, 14 and 15

The carrier in Example 13 was prepared in the same manner as in Example 1 but using, as the starting carrier components, 100% by mass of powdery silica gel (SiO₂, particle size: 15 μm) and, as the solid binding agent, 5% by mass of powder of α-starch (rice) (particle size: 150 μm) and 2% by mass of powdery cellulose (particle size: 150 μm), as the liquid binding agent, 5% by mass of colloidal silica (pH 9.0), and 52% by mass of diluted nitric acid water (nitric acid (HNO₃) concentration: 1.1% by mass, chlorine concentration: 1 ppm), kneading the fed starting materials for 18 minutes at room temperature, and calcining the dried molded product at 970° C. for 10 hours.

The carriers in Examples 14 and 15 were prepared in the same manner as in Example 13 but so setting the amounts of the kneaded product scratched by the scratching blade that the central particle sizes were 5.5 mm and 15.0 mm after calcining, and varying the amplitude of the crumpling board and the perforation size of the sieve depending on the particle sizes.

Table 5 shows the evaluated results of the carriers. The central particle sizes in Examples 13, 14 and 15 were 2.5 mm, 5.5 mm and 15.0 mm, respectively. It was confirmed that the pore volumes were large. A bi-modal pore distribution containing micropores and macropores was confirmed. The specific surface areas were large, and the side crushing strengths were large, too. A rhombic mesh pattern was observed on the surfaces of the carriers. The yields were large, too.

TABLE 5
Table 5 Starting materials fed for preparing carriers and evaluated results of the carriers

| | | | Example 13 | Example 14 | Example 15 |
|---|---|---|---|---|---|
| Starting | Powdery silica gel | mass % | 100 | 100 | 100 |
| materials | α-starch (rice) | mass % | 5 | 5 | 5 |
| | powdery cellulose | mass % | 2 | 2 | 2 |
| | colloidal silica | mass % | 5 | 5 | 5 |
| | diluted nitric acid water | mass % | 52 | 52 | 52 |
| Carrier | central particle size | mm φ | 2.5 | 5.5 | 15 |
| | pore volume | cc/g | 0.80~0.84 | 0.78~0.82 | 0.78~0.82 |
| | micropores | nm, cc/g | 6~30, 0.58~0.62 | 6~30, 0.58~0.62 | 6~30, 0.58~0.62 |
| | macropores | nm, cc/g | 200~900, 0.11~0.13 | 200~900, 0.11~0.13 | 200~900, 0.11~0.13 |
| | ultramacropores | nm, cc/g | — | — | — |
| | specific surface area | m²/g | 220~260 | 220~260 | 220~260 |
| | side crushing strength | kgf/particle | 3.5~4.1 | 4.2~5.0 | 6.7~7.5 |
| | surface | | rhombic mesh pattern | rhombic mesh pattern | rhombic mesh pattern |
| | yield | % | ≧90 | ≧90 | ≧90 |

### Comparative Example 8

A carrier was prepared in the same manner as in Example 14 but using no solid binding agent and using, as the liquid binding agent, 12% by mass of colloidal silica (pH 9.0).

As a result, a mono-modal pore distribution was recognized, the side crushing strength was 0.6 to 0.8 kgf/particle and the yield was 9 to 18%. Since no solid binding agent was used, the bi-modal pore distribution has disappeared, and it was confirmed that the side crushing strength and the yield have greatly decreased

### Comparative Example 9

A carrier was prepared in the same manner as in Example 14 but using no liquid binding agent and using, as the solid binding agent, 5% by mass of powder of α-starch (rice) (particle size: 150 g) and 2% by mass of powdery cellulose (particle size: 150 μn).

As a result, the side crushing strength was 4.2 to 5.0 kgf/particle and the yield was 51 to 61%. Since no liquid binding agent was used, it was confirmed that the yield has greatly decreased.

### Comparative Example 10

A carrier was prepared in the same manner as in Example 14 but using no diluted nitric acid water and using 52% by mass of natural water (chlorine concentration: 1 ppm).

As a result, the side crushing strength was 4.2 to 5.0 kgf/particle and the yield was 11 to 22%. Since no diluted nitric acid water was used, it was confirmed that the yield has greatly decreased.

### Comparative Example 11

A carrier was prepared in the same manner as in Example 14 but setting the chlorine concentration in the diluted nitric acid water to be 330 ppm.

As a result, the side crushing strength was 4.2 to 5.0 kgf/particle and the yield was 52 to 63%. In the calcining step, damage to the calciner was recognized due to the generation of an HCl gas. Since the chlorine concentration has increased, it was confirmed that the yield has greatly decreased and the calciner was adversely affected.

### Examples 16, 17 and 18

The carriers in Examples 16, 17 and 18 were prepared in the same manner as in Examples 13, 14 and 15 but using, as the solid binding agent, 5% by mass of powder of α-starch (rice) (particle size: 130 μm) and 2% by mass of powdery cellulose (particle size: 150 μm), and conducting the calcining at 1070° C. for 10 hours.

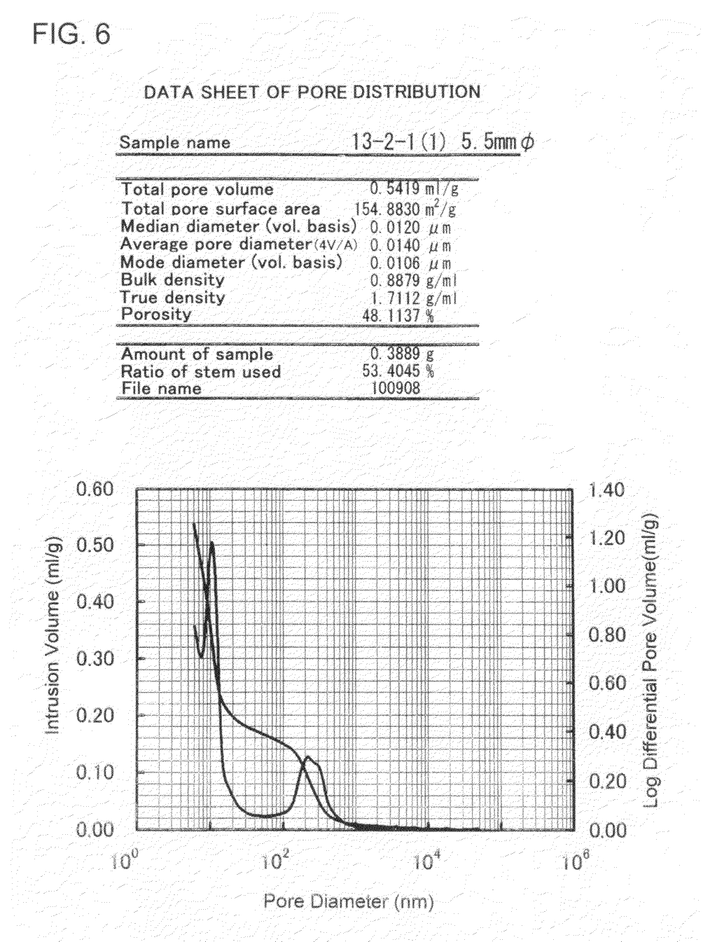

Table 6 shows the evaluated results of the carriers. FIG. 6 includes a data sheet of pore distributions of the carriers and a diagram showing integrated pore volume distributions and Log differential pore volume distributions of the carriers. The central particle sizes in Examples 16, 17 and 18 were 2.5 mm, 5.5 mm and 15.0 mm, respectively. It was confirmed that the pore volumes were large. A bi-modal pore distribution containing micropores and macropores was confirmed. The specific surface areas were large, and the side crushing strengths were large, too. A rhombic mesh pattern was observed on the surfaces of the carriers. The yields were large, too.

TABLE 6
Table 6 Starting materials fed for preparing carriers and evaluated results of the carriers

| | | | Example 16 | Example 17 | Example 18 |
|---|---|---|---|---|---|
| Starting | Powdery silica gel | mass % | 100 | 100 | 100 |
| materials | α-starch (rice) | mass % | 5 | 5 | 5 |
| | powdery cellulose | mass % | 2 | 2 | 2 |
| | colloidal silica | mass % | 5 | 5 | 5 |
| | diluted nitric acid water | mass % | 52 | 52 | 52 |
| Carrier | central particle size | mm φ | 2.5 | 5.5 | 15 |
| | pore volume | cc/g | 0.53~0.55 | 0.52~0.56 | 0.52~0.56 |
| | micropores | nm, cc/g | 6~20, 0.32~0.36 | 6~20, 0.32~0.36 | 6~20, 0.32~0.36 |
| | macropores | nm, cc/g | 150~600, 0.11~0.13 | 200~600, 0.11~0.13 | 200~600, 0.11~0.13 |
| | ultramacropores | nm, cc/g | — | — | — |
| | specific surface area | m²/g | 150~165 | 150~165 | 150~165 |
| | side crushing strength | kgf/particle | 6.5~7.5 | 9.5~10.5 | 11.0~12.0 |
| | surface | | rhombic mesh pattern | rhombic mesh pattern | rhombic mesh pattern |
| | yield | % | ≧90 | ≧90 | ≧90 |

### Examples 19, 20 and 21

The carrier in Example 19 was prepared in the same manner as in Example 13 but using, as the starting carrier components, 100% by mass of powdery silica gel (SiO₂, particle size: 10 μm) and, as the solid binding agent, 5% by mass of powder of α-starch (rice) (particle size: 130 μm) and 2% by mass of powdery cellulose (particle size: 150 μm), as the liquid binding agent, 5% by mass of colloidal silica (pH 9.5), and 52% by mass of diluted nitric acid water (nitric acid (HNO₃) concentration: 1.0% by mass, chlorine concentration: 1 ppm), and blending 6% by mass of wood powder (particle size: 200 μm) as the de-firing agent.

The carriers in Examples 20 and 21 were prepared in the same manner as in Example 19 but so setting the amounts of the kneaded product scratched by the scratching blade that the central particle sizes were 5.0 min and 15.0 mm after calcining, and varying the amplitude of the crumpling board and the perforation size of the sieve depending on the particle sizes.

Table 7 shows the evaluated results of the carriers. The central particle sizes in Examples 19, 20 and 21 were 2.5 mm, 5.0 mm and 15.0 mm, respectively. It was confirmed that the pore volumes were large. A tri-modal pore distribution containing micropores, macropores and ultramacropores was confirmed. The specific surface areas were large, and the side crushing strengths were large, too. A rhombic mesh pattern was observed on the surfaces of the carriers. The yields were large, too.

TABLE 7
Table 7 Starting materials fed for preparing carriers and evaluated results of the carriers

| | | | Example 19 | Example 20 | Example 21 |
|---|---|---|---|---|---|
| Starting | Powdery silica gel | mass % | 100 | 100 | 100 |
| materials | α-starch (rice) | mass % | 5 | 5 | 5 |
| | powdery cellulose | mass % | 2 | 2 | 2 |
| | colloidal silica | mass % | 5 | 5 | 5 |
| | diluted nitric acid water | mass % | 52 | 52 | 52 |
| | wood powder | mass % | 6 | 6 | 6 |
| Carrier | central particle size | mm φ | 2.5 | 5 | 15 |
| | pore volume | cc/g | 0.75~0.79 | 0.74~0.78 | 0.74~0.78 |
| | micropores | nm, cc/g | 6~30, 0.42~0.46 | 6~30, 0.42~0.46 | 6~30, 0.42~0.46 |
| | macropores | nm, cc/g | 200~900, 0.13~0.15 | 200~900, 0.13~0.15 | 200~900, 0.13~0.15 |
| | ultramacropores | nm, cc/g | ≈20000, 0.02~0.07 | ≈20000, 0.02~0.07 | ≈20000, 0.02~0.07 |
| | specific surface area | m²/g | 220~260 | 220~260 | 220~260 |
| | side crushing strength | kgf/particle | 3.5~4.1 | 4.2~5.0 | 6.7~7.5 |
| | surface | | rhombic mesh pattern | rhombic mesh pattern | rhombic mesh pattern |
| | yield | % | ≧90 | ≧90 | ≧90 |

The present invention exhibits effects as described below.

The invention provides a novel carrier having a pore volume in a range of 0.52 to 0.84 cc/g and a side crushing strength in a range of 2.2 to 11.0 kgf/particle.

The invention provides a novel carrier forming grooves in the surfaces thereof.

The invention provides a novel method of producing a carrier having a step of kneading the starting carrier components, solid binding agent, liquid binding agent and diluted nitric acid water.

What is claimed is:

1. A carrier having a pore volume lying in a range of 0.52 to 0.84 cc/g and a side crushing strength lying in a range of 2.2 to 11.0 kgf/particle.

2. The carrier of claim 1, wherein the material comprises any one of alumina, silica or zeolite, or any two or more of them in combination.

3. The carrier of claim 1, wherein the central particle size lies in a range of 2.5 to 15 mm.

4. A carrier having grooves formed in the surface thereof.

5. The carrier of claim 4, wherein the material comprises any one of alumina, silica or zeolite, or any two or more of them in combination.

6. The carrier of claim 4, wherein the central particle size lies in a range of 2.5 to 15 mm.

7. The carrier of claim 4, wherein the width of surfaces formed among the neighboring grooves is in a range of 0.20 to 0.30 mm, the depth of the grooves is in a range of 0.25 to 0.30 mm, and the pitch of the grooves is in a range of 0.25 to 0.35 mm.

8. A method of producing a carrier including a step of kneading the starting carrier components, solid binding agent, liquid binding agent and diluted nitric acid water.

9. The method of producing a carrier of claim 8, wherein the starting carrier components comprise any one of aluminum hydroxide, pseudoboehmite, γ-alumina, powdery silica gel, powdery natural silica or zeolite, or any two or more of them in combination.

10. The method of producing a carrier of claim 9, wherein the aluminum hydroxide is in a range of 1 to 30% by mass, the pseudoboehmite is in a range of 50 to 98% by mass, and the γ-alumina is in a range of 1 to 40% by mass.

11. The method of producing a carrier of claim 8, wherein the solid binding agent comprises any one of powder of α-starch (rice), α-starch (potato), α-starch (tapioca), funori (glue plant), crystalline cellulose or powdery cellulose, or any two or more of them in combination.

12. The method of producing a carrier of claim 11, wherein the solid binding agent is blended in an amount in a range of 1 to 10% by mass relative to the starting carrier components.

13. The method of producing a carrier of claim 8, wherein the liquid binding agent comprises any one of colloidal alumina, colloidal silica or polyvinyl alcohol, or any two or more of them in combination.

14. The method of producing a carrier of claim 13, wherein the liquid binding agent is blended in an amount in a range of 1 to 10% by mass relative to the starting carrier components.

15. The method of producing a carrier of claim 8, wherein the diluted nitric acid water has a nitric acid concentration in a range of 0.5 to 1.5% by mass and is blended in an amount in a range of 25 to 60% by mass in the starting materials that are fed.

16. The method of producing a carrier of claim 8, wherein the diluted nitric acid water has a chlorine concentration in a range of not larger than 100 ppm.

17. The method of producing a carrier of claim 8, wherein, as a de-firing agent, there may be used any one of wood powder, charcoal powder, rice flour, wheat flour, barley flour, buck wheat flour or corn, or any two or more of them in combination.

18. The method of producing a carrier of claim 17, wherein the de-firing agent is blended in an amount in a range of 3 to 15% by mass relative to the starting carrier components.
